(19) United States
(12) Patent Application Publication
(10) Pub. No.: US 2012/0018471 A1
(43) Pub. Date: Jan. 26, 2012

(54) TOUCH SCREEN VIDEO DISPLAY DEVICE MOUNTING SYSTEM SECURING TO VEHICLE SEAT HEADREST

(76) Inventors: Vernon Guillermo, Farmington Hills, MI (US); Chris Atwater, Rochester, MI (US)

(21) Appl. No.: 13/079,462

(22) Filed: Apr. 4, 2011

Related U.S. Application Data
(60) Provisional application No. 61/320,394, filed on Apr. 2, 2010.

(51) Int. Cl. B60R 7/00

(52) U.S. Cl. 224/275

(57) ABSTRACT

A mounting system for a vehicle seat having a headrest mounted thereto includes a vehicle engaging member having first second slots, the slots engaging dual posts of the headrest mount and terminating in a ball. A holder is provided that has a socket complementary to the ball. The holder has at least three securement points for a touch screen video display device to be retained therein. A mounting system for a vehicle seat having a headrest mounted thereto includes a vehicle engaging member having a housing with two hooks. At least one of the hooks is slidably adjusted to engage at least one post of a vehicle headrest mount. At least one hook extends from the housing. The housing also incorporates a ball. A holder is provided that has a socket complementary to the ball and includes at least three securement points for a touch screen video display device.

### RELATED APPLICATIONS

This application claims priority benefit of U.S. Provisional Application 61/320,394 filed 2 Apr. 2010; the contents of which are hereby incorporated by reference.

### FIELD OF THE INVENTION

The present invention relates in general to a touch screen video display device mounting system and in particular to a mounting system engaging headrest posts of a vehicle seat to safely mount such a device for backseat viewing.

### BACKGROUND OF THE INVENTION

Providing a video viewing experience to backseat passengers of a vehicle has to date relied upon factory installed audiovisual systems or strapping or otherwise attaching a portable DVD player to the back of a vehicle seat through resort to straps, hangers, or other such appliances. Still another alternative is simply for a backseat passenger to rest a portable DVD player on their lap. Original equipment manufacturers (OEMs) suffer from high cost and the inability to transfer the audiovisual system between vehicles. Portable DVD players, regardless of whether attached to a vehicle seat or resting on a backseat occupant lap, are fundamentally unsafe in the event of a vehicle collision with the mass of a DVD player mounted to a vehicle seat being sufficient to compromise safety of the seat while still being susceptible to moving in a collision to induce traumatic brain injury.

With the advent of comparative lightweight touch screen portable audiovisual devices such as the iPad, devices now exist that are both light enough in weight to not detract from the safety performance of a vehicle seat if portably mounted. Previous generations of devices having bubble switch type buttons are prone to fragment in the course of a collision and can cause injury.

Thus, there exists a need for a mounting system to safely support a touch screen video display device.

### SUMMARY OF THE INVENTION

A mounting system for a vehicle seat having a headrest mounted thereto includes a vehicle engaging member having a first slot and a second slot, the slots engaging dual posts of the headrest mount and terminating in a ball. A holder is provided that has a socket complementary to the ball. The holder has at least three securement points for a touch screen video display device to be retained therein. A mounting system for a vehicle seat having a headrest mounted thereto includes a vehicle engaging member having a housing with two hooks. At least one of the hooks is slidably adjusted to engage at least one post of a vehicle headrest mount. At least one hook extends from the housing. The housing also incorporates a ball. A holder is provided that has a socket complementary to the ball and includes at least three securement points for a touch screen video display device. It is appreciated that the relative position of the ball and the socket between an engaging member and a holder are readily reversed. A mounting system for a vehicle seat having a headrest mounted thereto is also provided that includes a base having a top, a side and a rear face and a through hole dimensioned to allow a post of the vehicle headrest support to extend therethrough. The base has a groove extending downward from the top or sideways from the side. The groove is in communication with a notch extending from the rear face. An insert has a platform with an arm fixidly attached to the platform. The arm terminates in a ball. A holder is provided that has a socket complementary to the ball and at least three securement points for a touch screen video display device.

### BRIEF DESCRIPTION OF THE DRAWINGS

FIG. 1 is an exploded view of an inventive mounting system;

FIG. 2 is a cross-sectional view of the insert and holder components of the system depicted in FIG. 1 along line A-A;

FIG. 3 is a perspective view of an alternate base operative in die inventive mounting system as depicted in FIG. 1;

FIG. 4 is a perspective view of an alternate holder operative in the mounting system depicted in FIG. 1 having a case enclosing the touch screen video display device, with the insert depicted in FIG. 4 being identical to that depicted in FIG. 1;

FIG. 5 is a cross-sectional view of the holder and insert depicted in FIG. 4 along line B-B;

FIG. 6 is a perspective view of an inventive mounting system with slots for a preset post spacing for a vehicle headrest;

FIG. 7 is a front perspective view of the inventive mounting system as depicted in FIG. 6;

FIG. 8 is an magnified view of the ball joint and retainer annulus thereof, as shown in FIG. 6;

FIG. 9A is a perspective view of the retainer annulus of FIG. 8;

FIG. 9B is a cross-sectional view of retainer annulus and ball shown in FIG. 6;

FIG. 10 is a perspective view of an inventive mounting system adaptable for securing to an adjustable vehicle headrest post separation;

FIG. 11A is a lateral cross sectional view through the headrest engaging portion of the inventive mounting system depicted in FIG. 10; and

FIG. 11B is a lateral cross sectional view through the headrest engaging portion of a mounting system similar to that shown in FIG. 10 that is well suited to engage a single post headrest with inverted hooks.

### DESCRIPTION OF THE PREFERRED EMBODIMENTS

The present invention has utility as a mounting system for securing a touch screen video display device to a vehicle seat having a headrest mounted to the vehicle seat by way of engaging a headrest post. The inventive mounting system satisfies crash safety guidelines to protect a rear seat passenger in the event of a collision and simultaneously does not compromise the safety rating of the vehicle seat to which the inventive mounting system is secured. The inventive mounting system also has the attribute of being readily transferred from one vehicle or one seat to another to overcome limitations of OEM video systems.

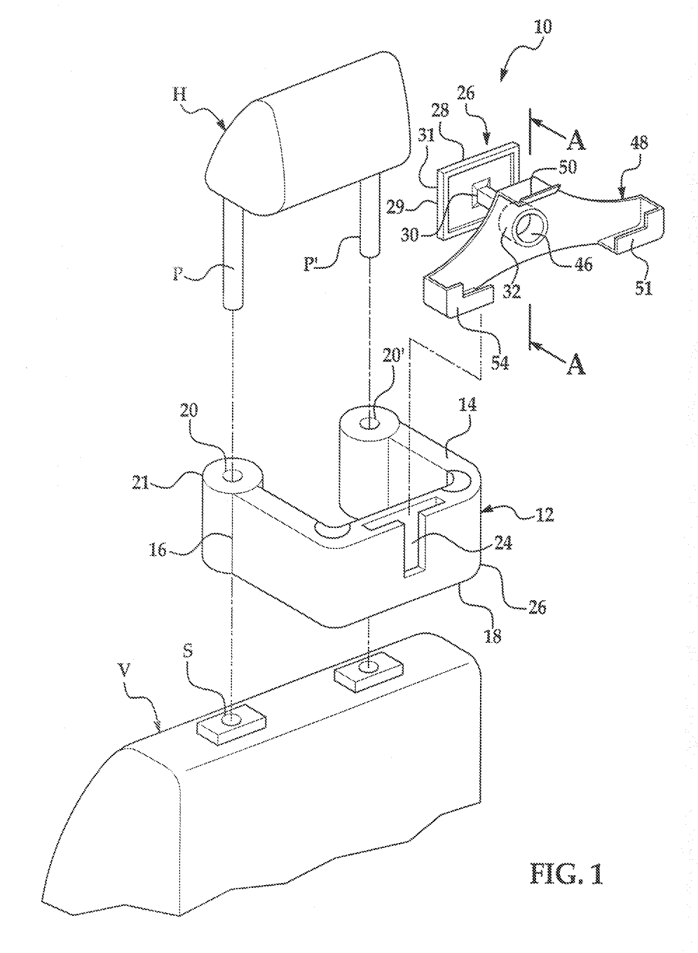

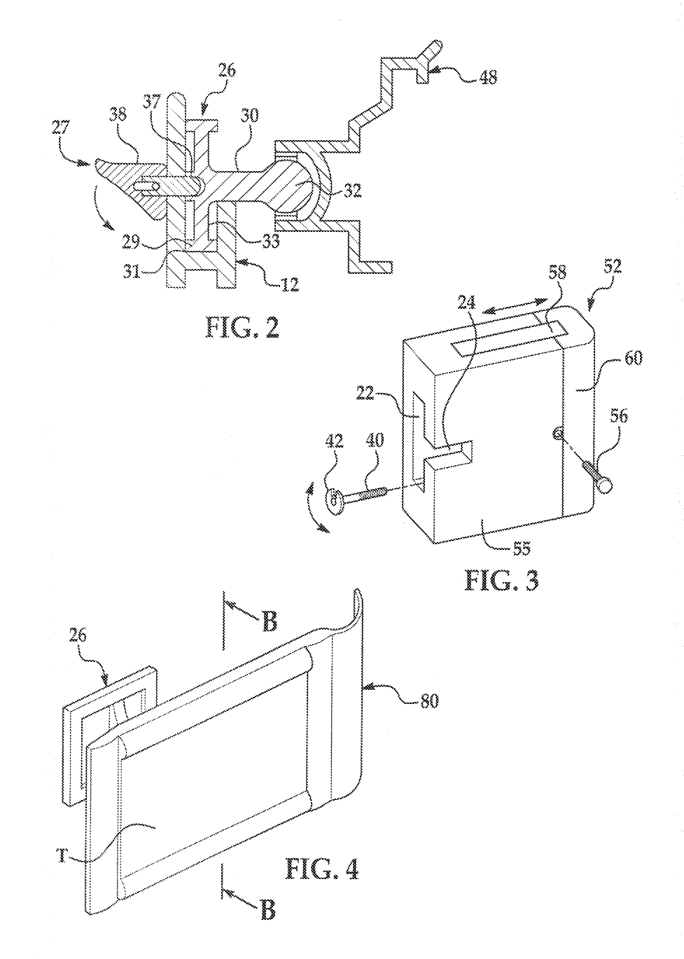

Referring now to FIGS. 1 and 2, an inventive mounting system is depicted generally at 10. The mounting system 10 has a base 12 having a top surface 14, a side 16, and a bottom surface 18. The base 12 has at least one through hole 20 dimensioned to allow a post P extending from a vehicle headrest H to enter the through hole 20 and extend therethrough to engage a socket S in a vehicle seat V. The base 12 is formed of an impact-resistant material such as ABS, polycarbonate, stamped metal, or a combination thereof. Optionally, the base 12 is a unitary piece that is monolithic in character and molded as a single unit. Optionally, a through hole 20 is surrounded by an elastomeric bushing that is more flexible than surrounding material from which the base 12 is formed. The base 12 has a groove 22 extending downward from the top 14; alternatively, it is appreciated that a groove 22 can extend from a side 16 as detailed later with respect to FIG. 3. The base 12 preferably has a second through hole 20′ adapted to allow post P′ to extend therethrough and into socket S′ so as to secure the base 12 to the vehicle seat V. It is appreciated that a bushing 21 affords a degree of flexibility to accommodate variations in headrest post positions P and P′ between different makes and models of vehicles. The groove 22 is in communication with a notch 24 extending from a rearward surface 26 of the base 12. The notch 24 extends in the same direction as the groove 22 and as depicted with respect to FIG. 1, both extend from the top 14 of the base 12 downward. The notch 24 is dimensioned to be narrower than, and bounded on both sides by, the groove 22. An insert 26 is included within mounting system 10, the insert 26 including a platform 28 and an arm 30. The arm is fixedly attached to the platform 28 and terminates in a ball joint 32. Platform 28 is dimensioned to slidably insert within groove 22 allowing the arm 30 to project from the rearward surface 26 through the notch 24. The platform 28 is optionally dimensionally reinforced around the edges thereof at 29 to form a frame 31. The frame 31 provides a secure fit with groove 22 while the space between the frame 31 and the central region of the platform 28 from which the arm 30 extends creates a controlled failure zone 33 in the event of a vehicle collision.

Upon insertion of the insert 26 into the groove 22 such that the arm 30 extends through the notch 24, a retainer mechanism 27 is provided to assure that the insert 26 remains engaged with the base 12 until a user selectively and intentionally disengages the same. It is appreciated that a variety of conventional retaining mechanisms 27 are operative herein, including a hook 37 engaging a platform 28 having a hinged handle 38 that based on position moves from a locked position to an unlocked position as best seen in FIG. 2.

Another exemplary retaining mechanism is depicted in FIG. 3 with a retaining fastener 40 engaging the base 52 proximal to the opening of the groove 22. The fastener 40 has a rotary asymmetric piece 42 engaged on the fastener 40 such that in a first rotary position the piece 42 allows the platform 28 to pass thereby and into the groove 22 whereas in other rotary positions the piece 42 precludes passage of the platform 28 from leaving the groove 22. Optionally, the piece 42 is spring biased. It is appreciated that a base 12 or base 52 is each readily formed from a multi-piece construct having the attribute of laterally telescoping to accommodate variations in headrests with respect to the number and dimensions of posts. Base 52 is depicted as formed from two telescoping portions 54 and 55 to provide a laterally dynamic sized through hole 58 to adapt so as to engage a variety of headrest post configurations. Upon the base 52 being properly adjusted, a fastener 60 such as a screw or spring-loaded locking pin, or other conventional locking mechanism, holds the base 52 fast around a vehicle headrest post.

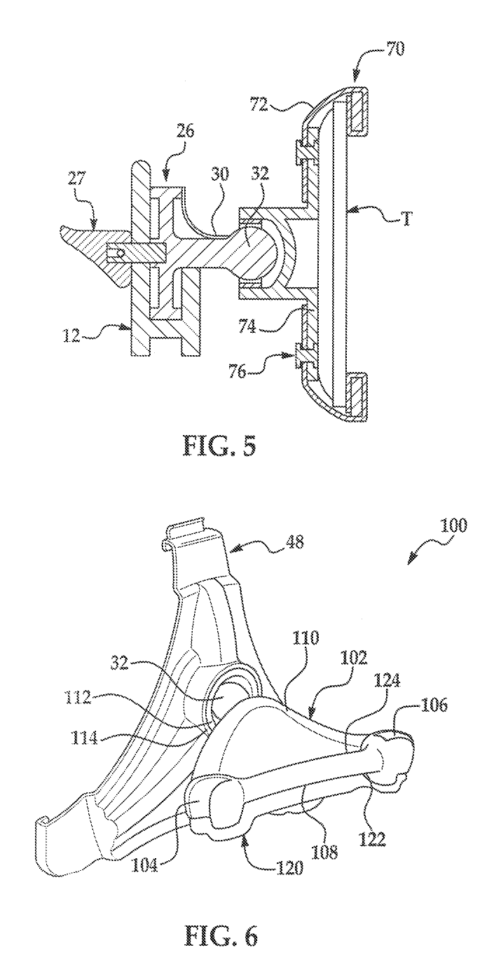

The ball joint 32 extending from the end of arm 30 engages a socket 46 extending from a holder 48. With engagement between the socket 46 and the ball joint 32, a holder 48 provides a wide range of angular movements. The holder 48 is characterized by at least three securement points for a touch screen video display device T, The at least three securement points 50, 51 and 54 are optionally provided as a three-sided frame into which the device T inserts. Such a frame is depicted in the context of an alternate holder 70, as depicted in FIGS. 4 and 5, in which a flexible cloth, leather, vinyl, or other conventional skin material forms such a frame. The holder 48 is formed from the same materials from which the insert 26 is formed, illustratively including ABS, polycarbonate, other impact-resistant polymers, aluminum, and steel. It is appreciated that the holder 48 is formed of a different material from this group relative to the insert 26.

As best shown in FIGS. 4 and 5 in which like numerals correspond to the meaning ascribed thereto with respect to the aforementioned figures, the holder 70 secures a flexible skin 72 to a flange 74 by way of a rivet 76 to form a frame adapted to engage device T. The frame optionally includes a flap 80 that is selectively closed through conventional means such as a snap fitting or hook-and-loop fastener to retain a device T within the holder 70.

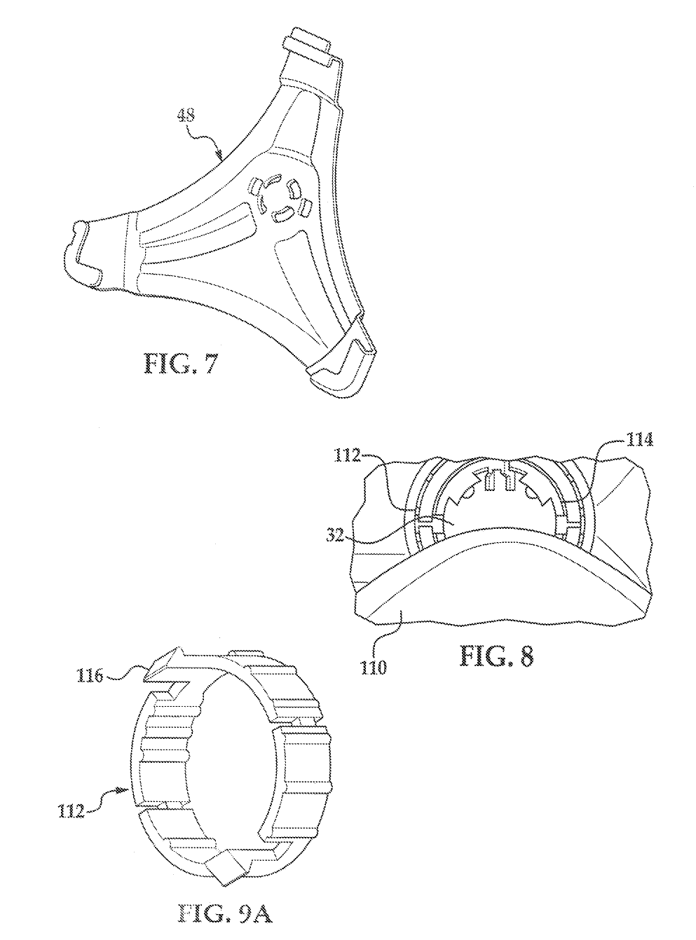

An inventive mounting system particularly well suited for securement to a vehicle headrest having fixed and preselected spacing between headrest posts is depicted generally at 100 with reference to FIGS. 6-9B in which like numerals correspond to the meaning ascribed thereto with respect to the aforementioned Figures. It is appreciated that the system 100 is able to engage headrest mounting posts without the removal of a vehicle headrest and as such is particularly well suited for usage with an active vehicle headrest containing electrical and sensor components providing communication between the headrest and seat components.

The system 100 includes a holder 48 coupled to ball 32. The ball 32 in physical communication with a vehicle engaging member 102 to form the joint. The vehicle engaging member 102 terminating in opposing slots 104 and 106 that engage post P and P [symbol] of a vehicle, as shown in the aforementioned figures. The slot 104 has an opening that is oriented relative to the opening of slot 106 of between 90 and 270 degrees with the understanding that 180 degrees represents opposing openings between slots 104 and 106. It is appreciated that non-opposing openings between slots 104 and 106 facilitate installment in that a post P is engaged by slot 104 and the system 100 is then sequentially rotated about the concentric axis created between the post P and slot 104 to create a pivotal engagement to post P [symbol] ; or vice versa such that post P [symbol] is engaged by slot 104 initially and post P is pivotally engaged by slot 106. It is appreciated that such a pivotal engagement of a vehicle limits flexural stress on the components of system 100. The components of system 100 are formed of the same materials from which base 12 with respect to FIGS. 1 and 2 is formed. Optionally, the vehicle engaging member 102 has a tensioning bar 108 spanning the area between slots 104 and 106, in instances when the bridging portion 110 between the ball joint 32 and slots 104 and 106 is arcuate as depicted in FIGS. 6-9. It is appreciated that the shape of the bridging portion 110 is not critical alone or in combination with the dimensions of tensioning bar 108 for the operation of the present invention. Rather, dimensions of bridging portion 110 alone or in combination with tensioning bar 108 are determined by factors illustratively including dimensions of a vehicle headrest, material properties from which engaging member 102 are formed, in governmental regulations regarding collision performance of inventive system 100.

Optionally, one or more spacers 120 are positioned intermediate between a bottom surface 122 or a top surface 124 of tensioning bar 108. The insert 120 operating as a spacer to limit movement of an inventive system when engaging a vehicle between a vehicle seat V and a headrest H. An insert 120 is readily formed of the impact resistant materials used to form base 12 of system 10 as well as polymeric foams, elastomers, fabrics, thermoplastics, and combinations thereof. It is further appreciated that such inserts 120 are readily formed integral with a tensioning bar 108, a bridging portion 110, or a combination thereof.

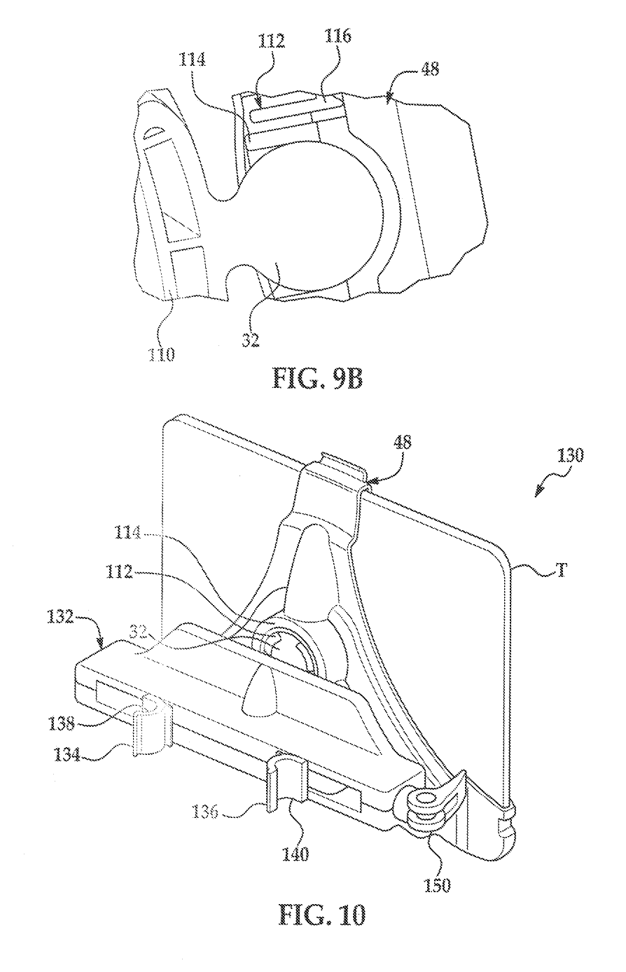

To facilitate proper orientation of the system 100 to support an engaged device T, an asymmetric annulus 112 engages the socket 114 into which the ball 32 is adopted to insert as best shown in FIG. 9B. The annulus 112, as best seen in FIG. 9A, has at least one retainer protrusion 116 that upon engaging a complementary aperture 118 in the socket 114 precludes rotation of the holder 48 around the axis defined by the ball 32. The annulus 112 is readily formed of elastic materials as well as impact resistant materials from which the engaging member 102 and holder 48 are, formed.

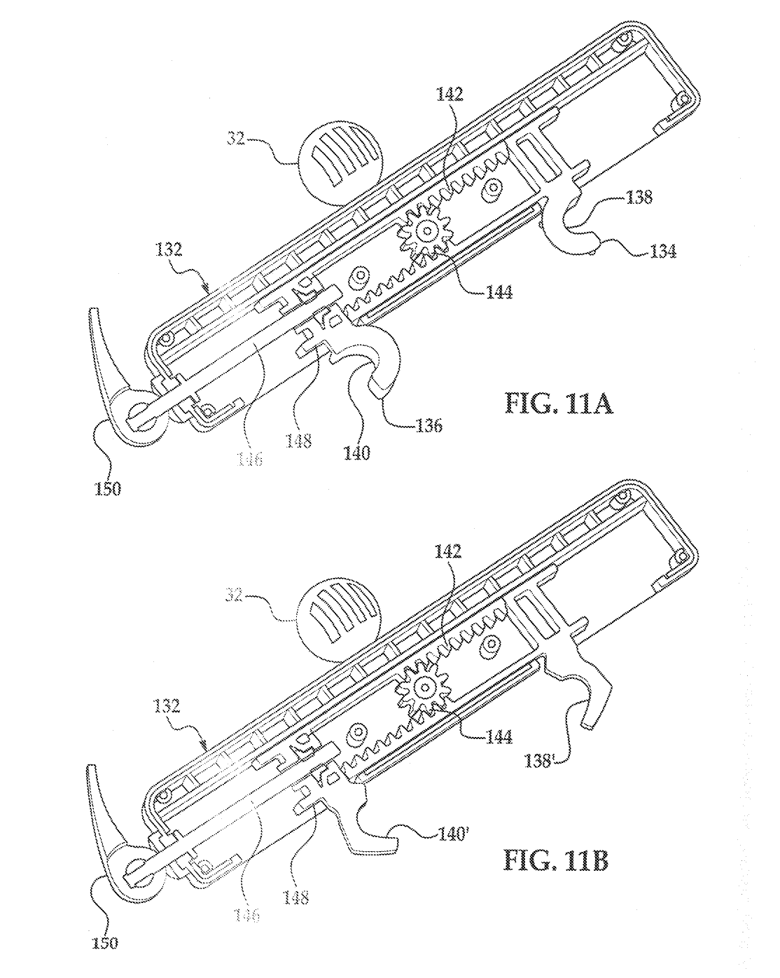

An inventive system well suited for securement to, a vehicle headrest having a variable or previously unknown separation distance between posts P and PD is shown generally at 130 in FIGS. 10 and 11A where like numerals detailed therein correspond to the meaning ascribed thereto with respect to the aforementioned figures. The system 130 has a holder 48 engaging a ball 32. Preferably, an annulus 112 is present in the socket 114 to control rotation of the holder 48 about the axis of rotation formed by the ball 32. For context, a device T is depicted as being held within holder 48. The ball 32 is preferably integral to a housing 132. The housing 132 having opposing hooks 134 and 136, the hooks 134 and 136 having surfaces 138 and 140, respectively adapted to engage posts P and P [symbol] of a vehicle headrest H. It is appreciated that simply by inverting the surfaces 138 and 140 as depicted in FIGS. 10 and 11, that an inventive system 130 is particularly well suited to engage a single rectilinear post supporting a headrest H extending from a vehicle V. Regardless of orientation of surfaces 138 and 140, these surfaces are tensioned against post structures between a headrest H and a vehicle seat V through the rotational movement of at least one rack gear 142 moving relative to a rotational gear 144. As depicted in FIG. 11A, a threaded fastener 146 rotating relative to a complementary threaded carriage 148 that enters into mechanical communication with at least one rack gear 142 and at least one of the hooks 134 or 136 operates to change the lateral displacement between surfaces 138 and 140. A conventional locking mechanism such as a quick release handle 150 is provided to selectively preclude or allow rotation of the fastener 146 relative to carriage 148. Preferably, the fastener 146, rack gear 142, rotating gear 144, hooks 134, and 136, are all formed of metal to assure positional stability upon engaging a vehicle and maintaining that position under tension for prolonged periods of time. It is appreciated that alternative lateral adjustment schemes are operative herein to tension hooks 134 and 136 relative to vehicle post structures. Such alternative hook tensioning mechanisms illustratively include those detailed in U.S. Pat. Nos. 1,483,603; 2,831,366; and 3,692,278.

It is appreciated that an inventive system siliar that depicted in FIG. 10 except for the contact surfaces being inverted is particularly well-suited to engage a single post headrest, as shown in FIG. 11B.

Patent applications and publications mentioned in the specification are indicative of the levels of those skilled in the art to which the invention pertains. These applications and publications are incorporated herein by reference to the same extent as if each individual application or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A mounting system for a vehicle seat having a headrest mounted thereto by dual posts, said system comprising:
a vehicle engaging member having a first slot, and a second slot adapted to engage the dual posts and terminating in a ball; and
a holder having a socket complementary to said ball joint and having at least three securement points for a touch screen video display device.

2. The system of claim 1 wherein said engaging member has a tensioning bar intermediate between said first slot and said second slot.

3. The system of claim 1 further comprising a spacer adjacent to said tensioning bar.

4. The system of claim 1 wherein said first slot and said second slot are oriented at an angle of between 90 and 270 degrees.

5. The system of claim 1 further comprising an annulus associated with said ball and said socket to form a lock therebetween.

6. The system of claim 1 further comprising a flexible skin together with said holder define a frame into which the touch screen video display inserts.

7. The system of claim 6 further comprising a flap closing an end of said frame around the touch screen video display device.

8. The system of claim 1 wherein at least one of said member or said holder is formed of an impact resistant polymer.

9. The system of claim 8 wherein said impact resistant polymer is poly(Acrylonitrile, Butadiene, Styrene), polycarbonate, or a combination thereof.

10. The system of claim 1 wherein the first slot and the second slot are aligned to sequentially engage the dual posts.

11. A mounting system for a vehicle seat having a headrest mounted thereto by at least one post, said comprising:
a vehicle engaging member having a housing with two hooks at least one of said two hooks slidably adjusted to engage at least one post and extending from said housing, said housing terminating in a ball;
a holder having a socket complementary to said ball joint and having at least three securement points for a touch screen video display device.

12. The system of claim 11 wherein said two hooks have post contacting surfaces that are in opposition.

13. The mounting system of claim 11 wherein said base is facing one another.

14. The system of claim 11 further comprising at least one rack gear sliding relative to a rotating gear to slide at least one of said two hooks wherein the groove extends from top of said base.

15. The system of claim 11 further comprising a quick release fitting to selectively allow at least one said hook to slide.

16. The system of claim 11 further comprising a carriage mechanically coupled to said at least one hook and a threaded fastener engaging said carriage to slide said at least one hook with rotation at said fastener.

17. The system of claim 11 further comprising a flexible skin together with said holder define a frame into which the touch screen video display inserts.

18. The system of claim 17 further comprising a flap closing an end of said frame around the touch screen video display device.

19. The system of claim 1 wherein at least one of said member or said holder is formed of an impact resistant polymer.

20. A mounting system for a vehicle seat having a headrest mounted thereto by at lest one post, said system comprising;
a base having a top, a side, and a rear face and a through hole dimensioned to allow the at least one post to extend therethrough, said base having a groove extending downward from the top or sideways from the side, the groove in communication with a notch extending from the rear face;
an exert having a platform with an arm fixedly attached to the platform, the arm terminating in a ball joint; and
a holder having a socket complementary to said ball joint and having at least three securement points for a touch screen video display device.
